(19) United States
(12) Patent Application Publication
(10) Pub. No.: US 2011/0085293 A1
(43) Pub. Date: Apr. 14, 2011

(54) INFORMATION STORAGE SYSTEM AND INFORMATION-STORAGE-DEVICE-MOUNTING SYSTEM

(75) Inventor: Yasuhiro MURAMATSU, Kawasaki (JP)

(73) Assignee: FUJITSU LIMITED, Kawasaki-shi (JP)

(21) Appl. No.: 12/899,795

(22) Filed: Oct. 7, 2010

(30) Foreign Application Priority Data
Oct. 9, 2009 (JP) 2009-235339

(51) Int. Cl. G06F 1/16

(52) U.S. Cl. 361/679.34

(57) ABSTRACT

An information storage system includes an information storage device to store information, a frame enclosing the information storage device, a vibration-damping member provided on the frame, a casing housing the frame together with the information storage device and supporting the information storage device with the frame interposed therebetween, and an adjustment mechanism to adjust a damping force of the vibration-damping member.

### CROSS-REFERENCE TO RELATED APPLICATION

This application is related to and claims the benefit of priority to Japanese Patent Application No. 2009-235339, filed on Oct. 9, 2009, the entire contents of which are incorporated herein by reference.

### FIELD

Embodiments discussed herein relate to an information storage system in which an information storage device is mounted, and to an information-storage-device-mounting system in which an information storage device is mounted.

### BACKGROUND

In recent years, disk array apparatuses in each of which a plurality of hard disk drives (HDDs) are mounted have increased in use. A disk array apparatus is an information storage system having an improved reliability in terms of information storage by including a plurality of HDDs for storing information so that information is restorable even if any of the HDDs fails.

In most HDDs, when information is written and read, vibrations occur because of operation mechanisms provided in the HDDs such as a rotating mechanism that rotates a magnetic disk and a moving mechanism that moves a magnetic head to positions where information is written and read. Such vibrations, if untreated, may trigger writing and reading errors. To prevent such errors, cushioning members that damp vibrations occurring in HDDs are often provided between, for example, each HDD and a casing in which the HDD is mounted (see Japanese Laid-open Patent Publication No. 11-144448, No. 2002-032979, and No. 2005-018835, for example).

In such a disk array apparatus, HDDs are in general secured to specific support frames, and the support frames together with the respective HDDs are housed in a casing. Thus, the HDDs are supported in the casing with the support frames interposed therebetween. Furthermore, in most cases, cushioning members, such as springs, are interposed between the casing and the support frames. The cushioning members damp vibrations occurring in the respective HDDs and vibrations transmitted from other HDDs and components in the disk array apparatus through the casing.

The disk array apparatus is desired to write and read information at higher speeds. As a matter of design, however, high-speed processing induces an increase in the speed of rotation or movement of the magnetic disk or the magnetic head provided in each of HDDs mounted in the apparatus, resulting in increased vibrations.

The disk array apparatus also has a plurality of slots in which the supporting frames having HDDs secured thereto are housed. The plurality of slots have individually different vibration characteristics including different resonance points at the occurrence of vibrations thereinside and different ways of transmission of external vibrations, because, for example, the positions thereof in the disk array apparatus are different. Therefore, if there is manufactured a disk array apparatus in which magnetic disks or heads of HDDs rotate or move at increased speeds for realizing high-speed processing, the difference in vibration characteristics between the slots may become pronounced. If the difference in vibration characteristics becomes pronounced, various kinds of vibrations having different characteristics may not sufficiently be damped only with the cushioning members described above.

In most disk array apparatuses, HDDs are secured to support frames simply by screwing or the like so that the HDDs can be replaced with other ones later. Some HDDs may be replaced with HDDs of different types in which the speeds of rotation of magnetic disks, for example, significantly differ from those of the original ones. In such a case, vibration characteristics before and after the replacement of HDDs may be significantly different from each other. Consequently, the vibrations that could be damped with the cushioning members described above before the replacement may not be damped sufficiently after the replacement.

While the above description concerns problems of vibrations occurring in exemplary disk array apparatuses when information is written and read, such problems are common to information storage systems including information storage devices that can cause failure because of vibrations and information-storage-device-mounting systems in which such information storage devices are mounted.

### SUMMARY

According to an aspect of the embodiment, an information storage system includes an information storage device which stores information, a frame enclosing the information storage device, a vibration-damping member provided on the frame, a casing housing the frame together with the information storage device and supporting the information storage device with the frame interposed therebetween, and an adjustment mechanism to adjust a damping force of the vibration-damping member.

The object and advantages of the embodiment will be realized and attained by the elements, features, and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 shows a disk array apparatus according to a specific embodiment of the information storage system;

FIG. 2 shows a state where one active frame having HDDs respectively secured thereto is pulled out of a disk array casing shown in FIG. 1;

FIG. 3 is an enlarged perspective view of one active frame having one HDD secured thereto;

FIGS. 4A to 4D show four sides, respectively, of the active frame having the HDD secured thereto shown in the perspective view of FIG. 3;

FIG. 5 is a perspective view of one disk cage;

FIG. 6 is an enlarged view of part E shown in FIG. 5;

FIG. 7 is a diagram for describing how a metal adjuster presses an arm of a leaf spring;

FIG. 8 is a graph showing frequency characteristics of vibrations that occurred when the HDDs housed in the disk array apparatus were in operation; and

FIG. 9 summarizes spring forces required for assuredly damping vibrations defined for twelve individual slots arranged in three rows and four columns.

### DESCRIPTION OF THE EMBODIMENTS

Specific embodiments of the information storage system and the information-storage-device-mounting system will now be described with reference to the drawings.

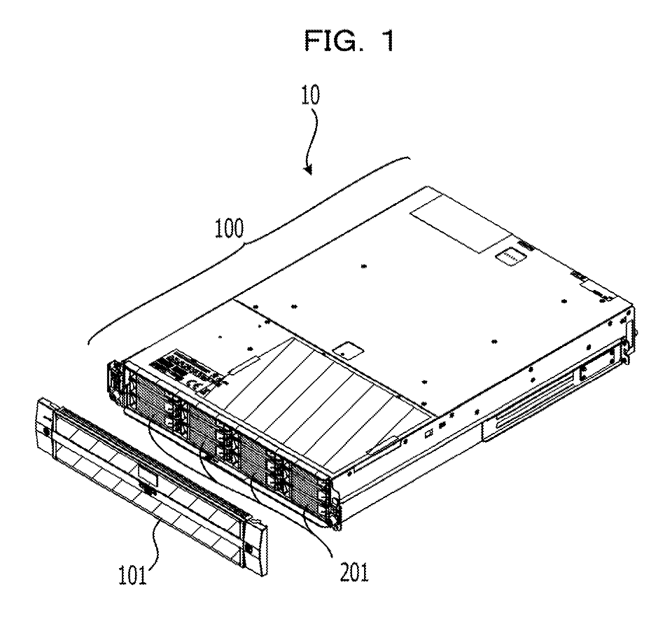

FIG. 1 shows a disk array apparatus according to a specified embodiment of the information storage system.

FIG. 1 shows a disk array apparatus 10 that houses twelve HDDs. In FIG. 1, the disk array apparatus 10 is shown with a front panel 101 thereof detached therefrom.

In the disk array apparatus 10, the HDDs are secured to active frames 200, respectively, each enclosing a corresponding one of the HDDs such that a gap is provided between the active frame 200 and part of the outer periphery of the HDD. The active frames 200 together with the respective HDDs are housed in a disk array casing 100. The combination of the disk array casing 100 and the active frames 200 according to the embodiment corresponds to a specified embodiment of the information-storage-device-mounting system.

In FIG. 1, handles 201 are exposed. The handles 201 are included in the active frames 200, respectively, and provide handholds for placing and removing the active frames 200 into and from the disk array casing 100. The handles 201 also function as heat dissipaters that dissipate heat generated when the HDDs are in operation. The disk array casing 100 has twelve slots arranged in three rows and four columns and in which the active frames 200 are housed, respectively, although any number of slots and configurations may be used.

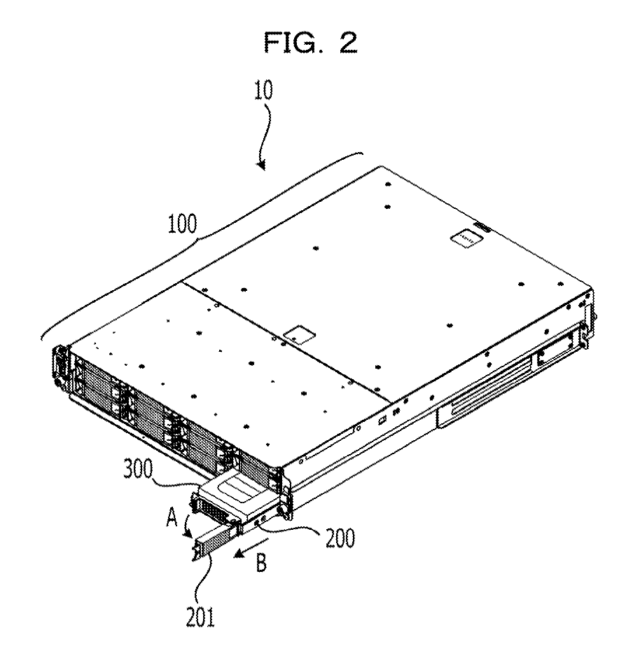

FIG. 2 shows a state where one of the active frames 200 having HDDs 300 respectively secured thereto is pulled out of the disk array casing 100 shown in FIG. 1.

As shown in FIG. 2, to remove any active frame 200 from the disk array casing 100, the handle 201 of that active frame 200 is turned in the direction of arrow A and is oriented toward the front of the disk array apparatus 10. By pulling the handle 201 in the foregoing state in the direction of arrow B, the active frame 200 is removed from the disk array casing 100. To place the active frame 200 into the disk array casing 100, the above removal procedure is performed in the reverse order.

The HDDs 300 are secured to the active frames 200, respectively, and are placed into and removed from the disk array casing 100 through the above operations of placing and removing the active frames 200. The HDDs 300 according to the embodiment are each an example of the information storage device.

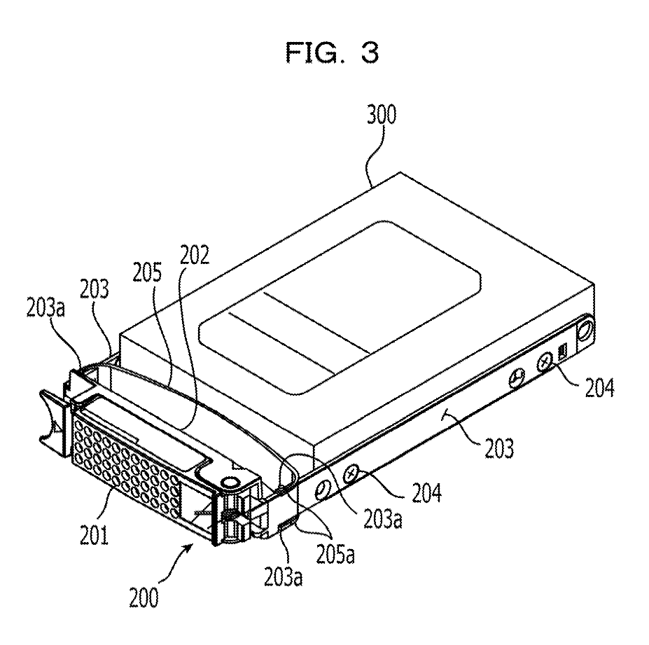

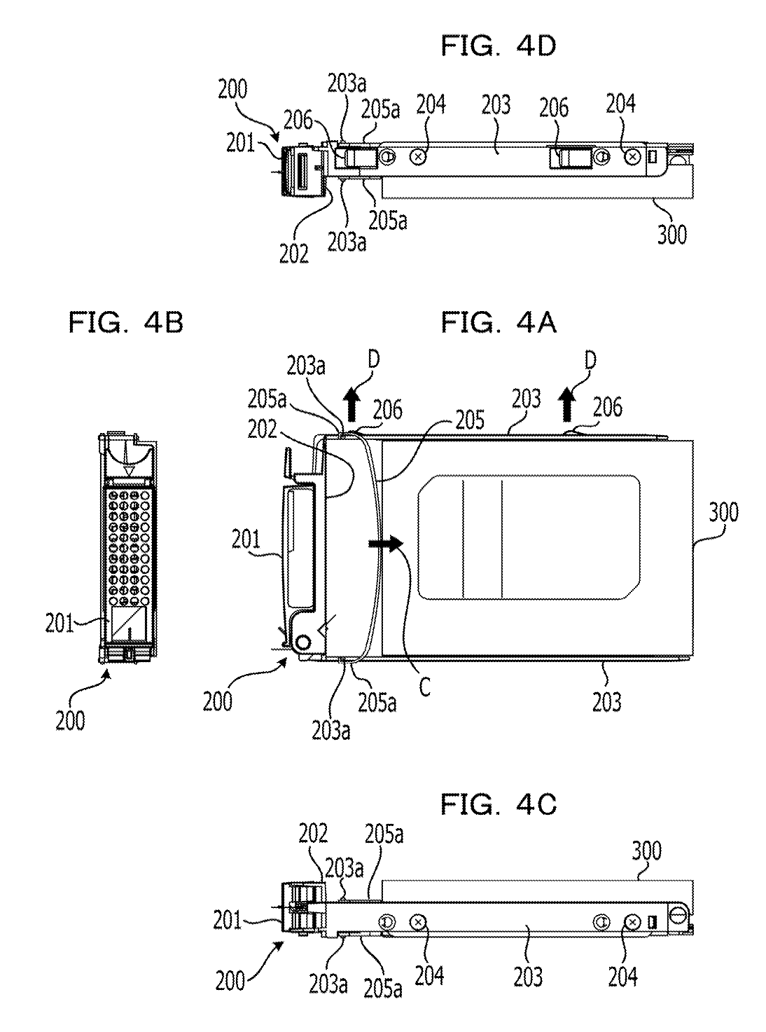

FIG. 3 is an enlarged perspective view of one active frame 200 having one HDD 300 secured thereto. FIGS. 4A to 4D show four sides, respectively, of the active frame 200 having the HDD 300 secured thereto shown in the perspective view of FIG. 3.

FIG. 4A is a top view of the active frame 200 having the HDD 300 secured thereto. FIG. 4B is a front view of the active frame 200. FIG. 4C is a right side view of the active frame 200. FIG. 4D is a left side view of the active frame 200. Herein, the right and left refer to the respective directions when seen from the front.

The active frame 200 having the HDD 300 secured thereto will now be described with reference to FIG. 3 and FIGS. 4A to 4D.

The active frame 200 is a metal frame that encloses the HDD 300, which has a rectangular shape, from the front, bottom, right, and left sides. The handle 201 is affixed to a front wall 202 of the active frame 200.

The HDD 300 is secured to the active frame 200 with a gap provided between the outer periphery thereof and the front wall 202. The HDD 300 is secured by being fastened to right and left sidewalls 203 of the active frame 200 with screws 204.

A leaf spring 205 having a strip-like shape is affixed to the active frame 200 with both ends thereof secured to the right and left sidewalls 203, respectively, of the active frame 200 in a manner described separately below. The leaf spring 205 is deformed to have a bend, and the projecting portion of the bend is pressed against the front face of the HDD 300. With the pressing of the projecting portion against the HDD 300, the leaf spring 205 produces a spring force acting on the HDD 300 secured to the active frame 200.

The portion of the active frame 200 according to the embodiment excluding the leaf spring 205 is an example of the frame body. The leaf spring 205 according to the embodiment is an example of the vibration-damping member. The spring force of the leaf spring 205 according to the embodiment acting on the HDD 300 is an example of the damping force.

The sidewalls 203 of the active frame 200 each have at the front end thereof two projections 203a projecting from upper and lower positions, respectively, as shown in FIG. 3 and in the side views of FIGS. 4C and 4D. Two arms 205a extend from each end of the leaf spring 205 in such a manner as to vertically hold a corresponding one of the sidewalls 203 of the active frame 200 therebetween. The arms 205a are hooked on the two projections 203a, respectively. That is, one of the arms 205a extending above the sidewall 203 is hooked on one of the projections 203a at the upper position of the sidewall 203, and the other arm 205a extending below the sidewall 203 is hooked on the other projection 203a at the lower position of the sidewall 203. With the hooking of the arms 205a on the projections 203a, the ends of the leaf spring 205 are secured to the active frame 200.

As described above, the leaf spring 205 is in contact with the front face of the HDD 300 at the projecting portion of the bend thereof, thereby producing a spring force acting on the HDD 300 as indicated by an arrow C shown in FIG. 4A. The spring force acting on the HDD 300 further produces a reactive force as another spring force acting on the front wall 202 of the active frame 200. With the foregoing spring forces, the leaf spring 205 functions as a cushioning member that damps vibrations such as those occurring with the operation of the HDD 300 and those transmitted from other HDDs 300.

As shown in FIGS. 4A and 4D, the left sidewall 203 of the active frame 200 has two sidewall springs 206. The sidewall springs 206 produce spring forces acting in the direction of arrows D shown in FIG. 4A. When the active frame 200 is housed in the disk array casing 100, the two sidewall springs 206 urge a wall of the disk array casing 100 facing the left sidewall 203.

The disk array casing 100 that houses the active frames 200 will now be described.

The disk array casing 100 has four disk cages, described below, arranged side by side in the horizontal direction and each having three stories for accommodating three active frames 200. The four disk cages in combination provide twelve slots arranged in three rows and four columns, as shown in FIGS. 1 and 2.

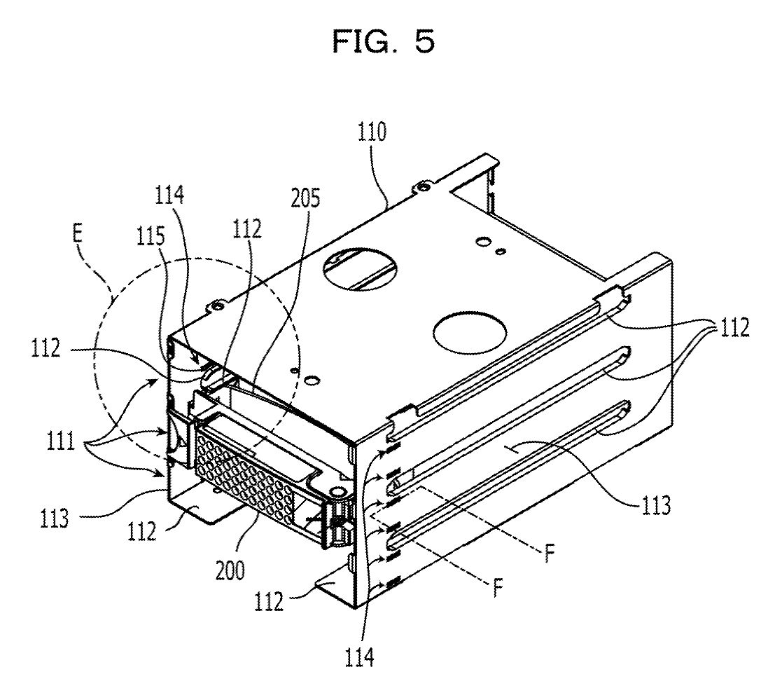

FIG. 5 is a perspective view of one disk cage 110.

As shown in FIG. 5, the disk cage 110 has three slots 111 in which the active frames 200 are to be housed respectively. The slots 111 are each provided with upper and lower rails 112 between which one active frame 200 to be housed therein is to be held. The active frame 200 is introduced into the slot 111 along the rails 112 and is supported by the rails 112 in the slot 111.

In the state where the active frame 200 is housed in the slot 111, the two sidewall springs 206 provided on the left sidewall 203 of the active frame 200 shown in FIGS. 4A and 4D urge a left one of two sidewalls 113 of the disk cage 110, the sidewalls 113 holding the active frame 200 from right and left. Thus, the active frame 200 in each slot 111 is pressed against the opposite sidewall 113, i.e., the right sidewall 113. The pressing of the active frame 200 with the two sidewall springs 206 provided on the left sidewall 203 of the active frame 200 contribute to stable supporting of the active frame 200 in the slot 111. The two sidewall springs 206 also function as cushioning members, in combination with the leaf spring 205 provided in the active frame 200, that damp vibrations such as those occurring with the operation of the HDD 300 and those transmitted from other HDDs 300 through the disk cage 110.

In the embodiment, the disk cage 110 is provided with adjustment mechanisms that adjust the spring forces of the leaf springs 205 of the active frames 200 housed in the slots 111.

The adjustment mechanisms each include the sidewalls 113 of the disk cage 110 and metal adjusters 115, the sidewalls 113 each having a plurality of holes 114, the metal adjusters 115 each being fitted over some of the holes 114.

The portion of the disk array casing 100 according to the embodiment excluding the adjustment mechanisms including the metal adjusters 115 and the sidewalls 113 of the disk cage 110 having the holes 114 is an example of the casing, and the adjustment mechanisms according to the embodiment including the metal adjusters 115 and the sidewalls 113 are each an example of the adjustment mechanism.

The holes 114 provided in the sidewalls 113 of each disk cage 110 are arranged in lines at positions corresponding to the positions of the arms 205a, shown in FIG. 3 and FIGS. 4A to 4D, extending from the ends of the leaf springs 205 of the active frames 200 housed in the slots 111. As described above, each leaf spring 205 has four arms 205a in total, specifically, two arms 205a for each of the two ends thereof. In the embodiment, as shown in FIG. 5, four holes 114 are provided for each of the arms 205a. That is, in each slot 111, four sets of four holes 114 are provided in the sidewalls 113 of the disk cage 110, more specifically, two sets of four holes 114 are provided in each of the right and left sidewalls 113.

Each set of holes 114 is provided with one metal adjuster 115 in a manner described below.

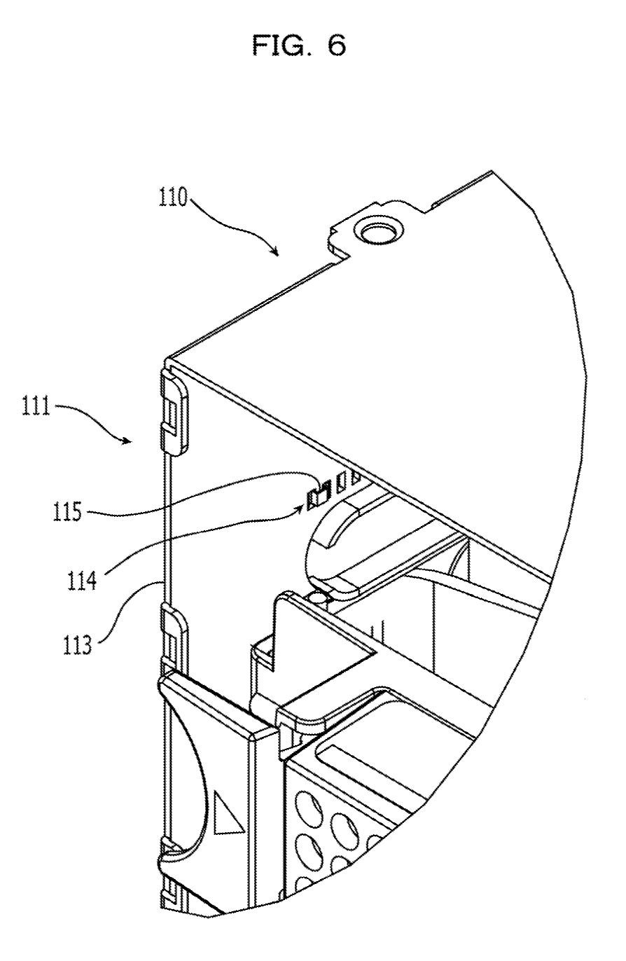

FIG. 6 is an enlarged view of part E shown in FIG. 5.

FIG. 6 shows, in an enlarged scale, one metal adjuster 115 fitted over some of the holes 114 in a lower one of the two sets of holes 114 provided in the left sidewall 113 and in the topmost slot 111.

The metal adjuster 115 is a metal fitting formed of a metal strip that is bent in a rectangular shape. As shown in FIG. 6, the metal adjuster 115 is fitted on the sidewall 113 in such a manner as to extend over two adjacent ones of the holes 114 and to project toward the inside of the disk cage 110. Thus, when an active frame 200 is housed in the slot 111, the metal adjuster 115 presses a corresponding one of the arms 205a of the leaf spring 205 extending from a position corresponding to the relevant set of four holes 114.

How the metal adjuster 115 presses the arm 205a of the leaf spring 205 will now be described.

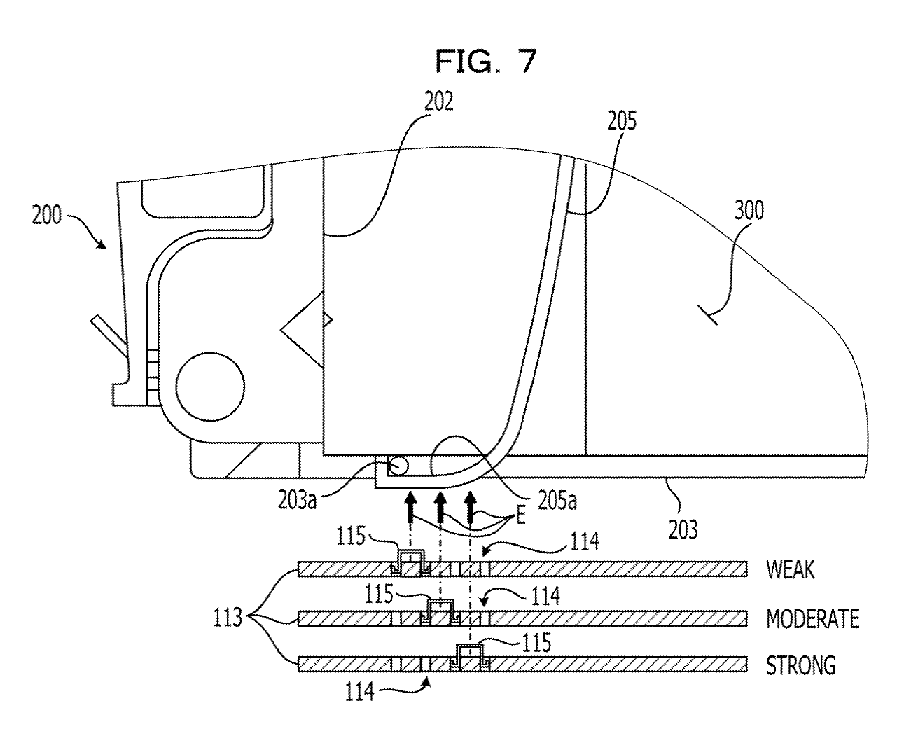

FIG. 7 is a diagram for describing how the metal adjuster 115 presses the arm 205a of the leaf spring 205.

FIG. 7 includes a diagram showing part of the active frame 200 shown in FIG. 5 and cross-sectional views of the right sidewall 113 of the disk cage 110 taken along the line F-F in FIG. 5.

The line F-F in FIG. 5 is a cutting line along a plane passing through an upper one of the two sets of holes 114 provided in the right sidewall 113 and in the middle slot 111. The metal adjuster 115 fitted over two holes 114 in the upper set of holes 114 as described above presses the upper one of the two arms 205a extending from the right end of the leaf spring 205, toward the inside of the active frame 200. With the foregoing pressing, a force acting to further bend the leaf spring 205 toward the HDD 300 is applied to the leaf spring 205. With the foregoing force, the spring forces of the leaf spring 205 urging the front wall 202 of the active frame 200 and the HDD 300 are increased from the spring forces produced before the active frame 200 is housed in the slot 111. In the embodiment, all of the four arms 205a extending from both ends of the leaf spring 205 are pressed by the respective metal adjusters 115. Accordingly, the leaf spring 205 additionally receives the forces applied by the four arms 205a acting to further bend the leaf spring 205. Thus, the spring forces of the leaf spring 205 are increased by the sum of the foregoing forces.

To summarize, in the embodiment, the active frames 200 are provided thereinside with the leaf springs 205, respectively, that damp vibrations, and the disk cage 110 housing the active frames 200 is provided with the adjustment mechanisms adjusting the spring forces of the leaf springs 205 and including the sidewalls 113 of the disk cage 110 and the metal adjusters 115. Therefore, in the embodiment, the degrees of adjustment with the adjustment mechanisms are changeable in accordance with the vibration characteristics of the individual slots 111, as described below. Furthermore, even in a case where the HDDs 300 secured to the active frames 200 are replaced with HDDs of other types, the degrees of adjustment with the adjustment mechanisms are changeable in accordance with the vibration characteristics expected after the replacement. Consequently, vibrations occurring inside the disk array apparatus 10 along with the operation of the HDDs 300 are damped appropriately in accordance with the vibration characteristics. That is, in the disk array apparatus 10 according to the embodiment, vibrations are assuredly damped.

In the embodiment, the HDDs 300, on which the spring forces of the leaf springs 205 act, each include an operation mechanism such as a rotating mechanism that rotates a magnetic disk or a moving mechanism that moves a magnetic head. Such an operation mechanism in the HDD 300 is a vibration source. In the embodiment, each leaf spring 205 is directly pressed against the HDD 300, whereby vibrations due to the operation of the vibration source is efficiently damped.

This means that a first applied embodiment is preferable in which the information storage device includes an operation mechanism that performs any one of writing and reading of information on the basis of a mechanical operation.

The HDDs 300 according to the embodiment are each an example of the information storage device according to the first applied embodiment.

In the embodiment, the leaf spring 205 is provided in the gap between the front wall 202 of the active frame 200 and the outer periphery of the HDD 300. Therefore, the leaf spring 205 produces a spring force acting on part of the outer periphery of the HDD 300 at the gap. Since the spring force acts at the position where the HDD 300 is most likely to vibrate in the active frame 200, vibrations due to the operation of the vibration source in the HDD 300 are effectively damped.

This means that a second applied embodiment is preferable in which the vibration-damping member produces a force acting on the part of the outer periphery of the information storage device at the gap.

The leaf spring 205 according to the embodiment is an example of the vibration-damping member according to the second applied embodiment.

In the embodiment, if the degrees of adjustment with the adjustment mechanisms are adjusted appropriately, the spring forces of the leaf springs 205 are automatically adjusted to appropriate intensities when the active frames 200 are simply housed in the slots 111. In such a configuration, since the spring forces are adjusted on the disk cage 110, the configurations of the active frames 200 may be made uniform for all of the slots 111, whereby costs may be reduced.

This means that a third applied embodiment is preferable in which the adjustment mechanism provided on the casing mechanically acts on the vibration-damping member when the frame body is housed in the casing, thereby adjusting the damping force of the vibration-damping member.

The adjustment mechanisms according to the embodiment including the sidewalls 113 and the metal adjusters 115 are each an example of the adjustment mechanism according to the third applied embodiment.

In the embodiment, the leaf spring 205 is employed as a spring whose spring force is to be adjusted, and the adjustment of the spring force is realized by a simple method in which the arms 205a of the leaf spring 205 are pressed by the metal adjusters 115, as described above.

This means that a fourth applied embodiment is preferable in which the vibration-damping member is a spring having a strip-like shape and is secured at both ends thereof to the frame body with a bend produced therein, a projecting portion of the bend being pressed against the information storage device. Furthermore, in the fourth applied embodiment, the adjustment mechanism adjusts a spring force of the spring by pressing a portion of the spring between a portion secured to the frame body and a portion pressed against the information storage device.

The leaf spring 205 according to the embodiment is an example of the vibration-damping member according to the fourth applied embodiment. The adjustment mechanisms according to the embodiment including the sidewalls 113 and the metal adjusters 115 are each an example of the adjustment mechanism according to the fourth applied embodiment.

A method of adjusting the degrees of adjustment in accordance with the vibration characteristics of the HDDs 300 housed in the slots 111 of the disk array apparatus 10 according to the embodiment will now be described specifically.

As described above, the metal adjusters 115 are each fitted on the sidewall 113 in such a manner as to extend over two adjacent ones of the holes 114. In the embodiment, the metal adjuster 115 may be removably inserted. Therefore, considering which two of the four holes 114 for each arm 205a are appropriate, the metal adjuster 115 is fitted to any of three different fitting positions defined relative to the arm 205a. In the embodiment, as described above, four metal adjusters 115 are provided for each of the slots 111, and the four metal adjusters 115 are fitted to the same position in terms of the three fitting positions.

FIG. 7 schematically shows the three fitting positions at any of which each metal adjuster 115 is to be fitted.

As described above, the arm 205a of the leaf spring 205 is hooked on the projection 203a provided on the sidewall 203 of the active frame 200. The three fitting positions are separated, for example, 5 mm each other. As indicated by arrows E shown in FIG. 7, the metal adjuster 115 fitted to any of the three fitting positions presses a corresponding one of three pressing positions defined at different distances from the projection 203a toward the projecting portion of the bend in the leaf spring 205.

The closer the pressing position is to the projection 203a, the harder it is for the arm 205a of the leaf spring 205 to move when pressed. Furthermore, the smaller the movement of the arm 205a, the weaker the above-described effect of increasing the spring force of the leaf spring 205 acting on the HDD 300. Accordingly, among the three fitting positions, when the metal adjuster 115 is fitted to the position closest to the projection 203a, the effect of increasing the spring force is the weakest. When the metal adjuster 115 is fitted to the middle fitting position, the effect of increasing the spring force is moderate. When the metal adjuster 115 is fitted to the position farthest from the projection 203a, the effect of increasing the spring force is the strongest.

Thus, in the embodiment, the degree of adjustment of the spring force of the leaf spring 205 may be changed easily by appropriately selecting the position to which the metal adjuster 115, which is removably inserted, is to be fitted from among the three fitting positions.

This means that, in the fourth applied embodiment in which the vibration-damping member is a spring having a strip-like shape with a bend produced therein, a fifth applied embodiment is further preferable in which the adjustment mechanism includes a pressing member pressed against the spring, and a holder holding the pressing member and having a plurality of fitting positions to and from one of which the pressing member is removably inserted.

The adjustment mechanisms according to the embodiment including the sidewalls 113 and the metal adjusters 115 are each an example of the adjustment mechanism according to the fifth applied embodiment. The metal adjusters 115 according to the embodiment are each an example of the pressing member according to the fifth applied embodiment. The sidewalls 113 according to the embodiment are each an example of the holder according to the fifth applied embodiment. The holes 114 according to the embodiment provided in the sidewalls 113 are examples of the fitting positions according to the fifth applied embodiment.

To what intensity the spring force of the leaf spring 205 acting on the HDD 300 is to be adjusted with the metal adjusters 115 will now be described.

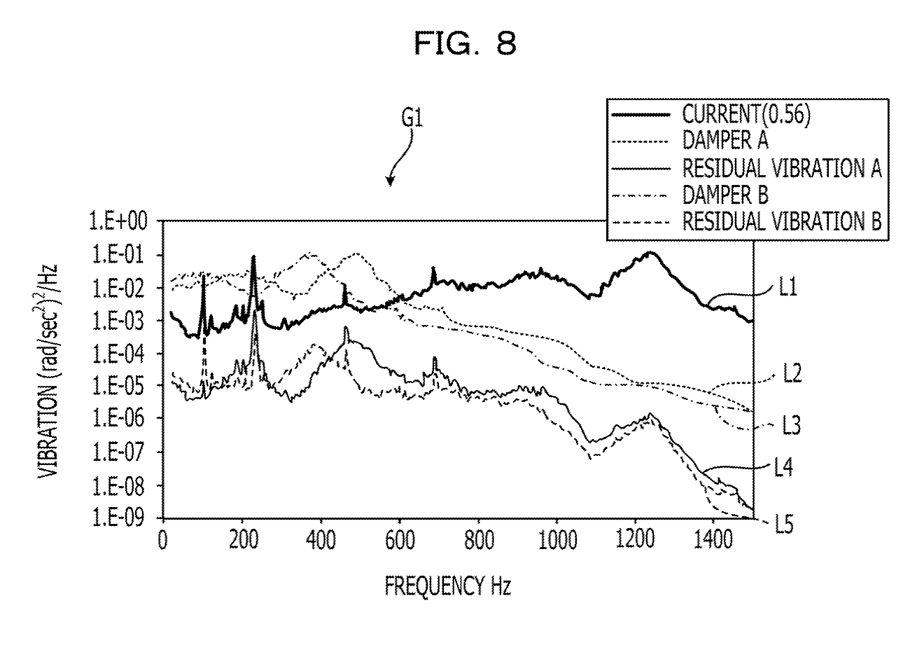

FIG. 8 is a graph showing frequency characteristics of vibrations that occurred when the HDDs 300 housed in the disk array apparatus 10 were in operation.

Specifically, the graph G1 in FIG. 8 shows frequency characteristics of vibrations observed on the outer surface of one of the HDDs 300 when all of the twelve HDDs 300 housed in the disk array apparatus 10 operated substantially simultaneously. In the graph G1, the horizontal axis represents the frequency, and the vertical axis represents the normalized vibration strength.

In the graph G1, a first line L1, which is a bold solid line, represents the frequency characteristic of vibrations when an HDD 300 to be observed was secured to the active frame 200 without using the leaf spring 205. When the frequency characteristic represented by the first line L1 was obtained, the eleven HDDs 300 other than the HDD 300 to be observed were also secured to the active frames 200 without using the leaf springs 205. As can be seen from the shape of the first line L1, when the leaf springs 205 were not used, peaks of the vibrations appeared at high frequencies around 1200 Hz and at low frequencies around 200 Hz.

The graph G1 also shows the damping characteristics of two leaf springs 205 producing two different spring forces to be applied to the HDD 300.

In the graph G1, a second line L2, which is a bold dashed line, represents the damping characteristic of one of the leaf springs 205 that produces a relatively strong spring force, and a third line L3, which is an alternate long and short dashed line, represents the damping characteristic of the other leaf spring 205 that produces a relatively weak spring force. As can be seen from the lines L2 and L3, both of the two leaf springs 205 produced sufficient damping effects on the peaks of vibrations at high frequencies appeared in the case where the leaf springs 205 were not used. Particularly, the leaf spring 205 producing the weaker spring force and having the resonance point at a low frequency exhibited a greater damping effect (see the third line L3). Meanwhile, the leaf spring 205 producing the stronger spring force and having the resonance point at a high frequency exhibited a greater damping effect on the peaks of vibrations at low frequencies of 200 Hz or lower (see the second line L2).

Furthermore, in the graph G1, a fourth line L4, which is a thin solid line, represents the frequency characteristic of vibrations occurred when the HDD 300 to be observed was secured to the active frame 200 with the leaf spring 205 producing a relatively strong spring force provided in the active frame 200, and a fifth line L5, which is a thin dashed line, represents the frequency characteristic of vibrations occurred when the HDD 300 to be observed was secured to the active frame 200 with the leaf spring 205 producing a relatively weak spring force provided in the active frame 200. As can be seen from the lines L4 and L5, the peaks of vibrations at high frequencies were sufficiently damped in accordance with the damping characteristics of the leaf springs 205 in both of the two cases. Meanwhile, the peaks of vibrations at low frequencies of 200 Hz or lower are damped more effectively in the case where the leaf spring 205 producing the stronger spring force is used (see the fourth line L4).

Thus, to what intensity the spring force produced by the leaf spring 205 provided in the active frame 200 is to be adjusted depends on how high-frequency and low-frequency peaks appear in the vibration characteristic when the leaf spring 205 is not used. As in the example shown in FIG. 8, when a large peak appears in vibrations at low frequencies and the low-frequency peak should be damped significantly, the spring force of the leaf spring 205 is desired to be strong, even by sacrificing the damping effect a little on high-frequency vibrations. In contrast, when the peak of vibrations at low frequencies is not very large, the spring force of the leaf spring 205 is desired to be weak, focusing on the peak of vibrations at high frequencies. If the peaks of vibrations at high frequencies and low frequencies both should be damped with a good balance, the spring force of the leaf spring 205 is desired to be moderate.

In the embodiment, the strong spring force required for significantly damping the low-frequency peak is obtained when the metal adjuster 115 is fitted to the fitting position farthest from the projection 203a shown in FIG. 7. The weak spring force required for significantly damping the high-frequency peak is obtained when the metal adjuster 115 is fitted to the fitting position closest to the projection 203a shown in FIG. 7. The moderate spring force required for damping the low-frequency and high-frequency peaks with a good balance is obtained when the metal adjuster 115 is fitted to the middle fitting position shown in FIG. 7.

The disk array apparatus 10 according to the embodiment has twelve slots 111 arranged in three rows and four columns, as described above. Strictly speaking, the slots 111 exhibit individually different characteristics for vibrations occurring in the disk array apparatus 10. Moreover, vibrations transmitted to individual ones of the twelve slots 111 from the HDDs 300 in the other eleven slots 111 are different from each other, technically.

In the embodiment, the spring force for assuredly damping vibrations is selected from the three intensities for each of the twelve slots 111 in accordance with the vibration characteristic of the slot 111.

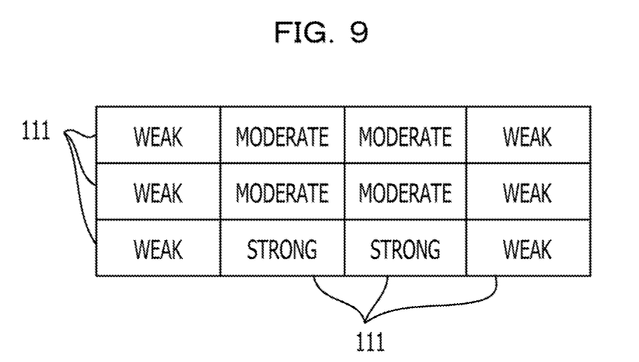

FIG. 9 is a schematic diagram summarizing the spring forces required for assuredly damping vibrations defined for the twelve individual slots 111 arranged in three rows and four columns.

Referring to FIG. 9, for example, the required spring force of the leaf spring 205 for the slot 111 in the first row in the first column is weak, the required spring force of the leaf spring 205 for the slot 111 in the first row in the second column is moderate, and the required spring force of the leaf spring 205 for the slot 111 in the third row in the second column is strong.

In the embodiment, the spring forces of the leaf springs 205 provided in the active frames 200 housed in the slots 111 are individually adjusted with the metal adjusters 115 fitted to the slots 111. Therefore, when the spring forces for some of the active frames 200 should be changed in, for example, replacing the HDDs 300, an efficient work of adjusting the spring forces for the desired active frames 200 may be performed.

This means that a sixth applied embodiment is preferable in which the frame body includes a plurality of frame bodies, and the casing has a plurality of housing spaces in which the frame bodies are housed respectively. Furthermore, in the sixth applied embodiment, the adjustment mechanism includes a plurality of adjustment mechanisms, and the vibration-damping member includes a plurality of vibration-damping members, the adjustment mechanisms individually adjusting the damping forces of the vibration-damping members provided on the respective frame bodies housed in the respective housing spaces.

The portion of the disk array casing 100 according to the embodiment excluding the adjustment mechanisms including the metal adjusters 115 and the sidewalls 113 of the disk cage 110 having the holes 114 is an example of the casing according to the sixth applied embodiment. The adjustment mechanisms according to the embodiment including the metal adjusters 115 and the sidewalls 113 are examples of the adjustment mechanisms according to the sixth applied embodiment.

In the embodiment, the metal adjusters 115 are fitted to fitting positions corresponding to the spring forces defined for the individual slots 111. Therefore, vibrations on the HDDs 300 housed in the individual slots 111 are damped appropriately.

This means that a seventh applied embodiment is preferable in which the frame body includes a plurality of frame bodies, and the casing has a plurality of housing spaces in which the frame bodies are housed respectively. Furthermore, in the seventh applied embodiment, the adjustment mechanism includes a plurality of adjustment mechanisms provided in the respective housing spaces of the casing, and the vibration-damping member includes a plurality of vibration-damping members, the adjustment mechanisms mechanically acting on the respective vibration-damping members when the frame bodies are housed in the respective housing spaces, thereby adjusting the damping forces of the vibration-damping members so as to be suitable for the respective housing spaces.

The portion of the disk array casing 100 according to the embodiment excluding the adjustment mechanisms including the metal adjusters 115 and the sidewalls 113 of the disk cage 110 having the holes 114 is an example of the casing according to the seventh applied embodiment. Furthermore, the adjustment mechanisms according to the embodiment including the metal adjusters 115 and the sidewalls 113 are examples of the adjustment mechanisms according to the seventh applied embodiment.

In an eighth applied embodiment, the metal adjuster 115 may be slidably mounted on the sidewall 113. The sidewall 113 may include a track between, for example, the first and third fitting positions illustrated in FIG. 7. The metal adjuster 115 may be mounted on the sidewall 113 such that the metal adjuster may slide along the sidewall 113 to one of a plurality of positions between the first and third fitting positions. This enables the metal adjuster 115 to exert various levels of force on the leaf spring 205 as opposed to one level of force for each fitting position.

The metal adjuster 115 may also include a locking mechanism. The locking mechanism may be used to lock the metal adjuster 115 in a particular position along the track in the sidewall 113. In this manner, the metal adjuster 115 may be maintained in a desired position to continuously exert a desired amount of force on the leaf spring 205. Preferably, the locking mechanism may be selectively locked so that the locking mechanism may be locked and unlocked to enable the metal adjuster 115 to be moved to and locked in different positions.

While the specific embodiment of the information storage system described above concerns an exemplary case of the disk array apparatus 10, the information storage system is not limited thereto. The information storage system may also be applied to other information storage systems including information storage devices, such as HDDs, that may cause failure due to vibrations.

While the specific embodiment of the information storage system described above concerns an exemplary case of the disk array apparatus 10 in which twelve HDDs 300 are housed in three rows and four columns, the information storage system is not limited thereto. The information storage system may also be applied to a system in which fewer or more than twelve HDDs are housed in another arrangement.

While the example of the adjustment mechanism described above concerns the adjustment mechanism that adjusts the spring force of the leaf spring 205 to be any of three intensities, the adjustment mechanism is not limited thereto. The adjustment mechanism may also adjust the spring force to be any of fewer or more than three intensities or to be changed steplessly, not stepwise.

While the example of the adjustment mechanism described above concerns the adjustment mechanism that adjusts the spring force of the leaf spring 205 with the metal adjusters 115 fitted to the disk cage 110, the adjustment mechanism is not limited thereto. The adjustment mechanism may also adjust the spring force of the spring with, for example, a mechanism provided on the inside of the active frame 200.

While the example of the vibration-damping member described above concerns the leaf spring 205, the vibration-damping member is not limited thereto. The vibration-damping member may also be a spring, such as a coil spring, other than a leaf spring.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. An information storage system comprising:
an information storage device to store information;
a frame enclosing the information storage device;
a vibration-damping member provided on the frame;
a casing housing the frame together with the information storage device and supporting the information storage device with the frame interposed therebetween; and
an adjustment mechanism to adjust a damping force of the vibration-damping member.

2. The information storage system according to claim 1, wherein the information storage device includes an operation mechanism that performs any one of writing and reading of information based on a mechanical operation.

3. The information storage system according to claim 1, wherein the vibration-damping member produces a force acting on the part of the outer periphery of the information storage device.

4. The information storage system according to claim 1, wherein the adjustment mechanism is provided on the casing.

5. The information storage system according to claim 4, wherein the adjustment mechanism mechanically acts on the vibration-damping member when the frame is housed in the casing, thereby adjusting the damping force of the vibration-damping member.

6. The information storage system according to claim 1,
wherein the frame includes a plurality of frames, and the casing includes a plurality of housing spaces in which the frames are housed respectively, and
wherein the adjustment mechanism includes a plurality of adjustment mechanisms, and the vibration-damping member includes a plurality of vibration-damping members, the adjustment mechanisms individually adjusting the damping forces of the vibration-damping members provided on the respective frames housed in the respective housing spaces.

7. The information storage system according to claim 1,
wherein the frame includes a plurality of frames, and the casing has a plurality of housing spaces in which the frames are housed respectively, and
wherein the adjustment mechanism includes a plurality of adjustment mechanisms provided in the respective housing spaces of the casing, and the vibration-damping member includes a plurality of vibration-damping members, the adjustment mechanisms mechanically acting on the respective vibration-damping members when the frames are housed in the respective housing spaces, thereby adjusting the damping forces of the vibration-damping members so as to be suitable for the respective housing spaces.

8. The information storage system according to claim 1,
wherein the vibration-damping member includes a spring having a strip-like shape and is secured at both ends thereof to the frame with a bend produced therein, a projecting portion of the bend being pressed against the information storage device, and
wherein the adjustment mechanism adjusts a spring force of the spring by pressing a portion of the spring between a portion secured to the frame and a portion pressed against the information storage device.

9. The information storage system according to claim 8, wherein the adjustment mechanism includes a pressing member pressed against the spring, and a holder holding the pressing member and having a plurality of fitting positions into which the pressing member is removably inserted.

10. An information-storage-device-mounting system comprising:
a frame enclosing an information storage device;
a vibration-damping member provided on the frame;
a casing housing the frame together with the information storage device and supporting the information storage device with the frame interposed therebetween; and
an adjustment mechanism to adjust a damping force of the vibration-damping member.
